(19) United States
(12) Patent Application Publication
(10) Pub. No.: US 2007/0082741 A1
(43) Pub. Date: Apr. 12, 2007

(54) Scheme for use in testing software for computer entertainment systems

(75) Inventor: Jie Xu, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment America Inc., Foster City, CA (US)

(21) Appl. No.: 11/247,059

(22) Filed: Oct. 11, 2005

(51) Int. Cl. A63F 13/00

(52) U.S. Cl. 463/43

(57) ABSTRACT

Scheme for use in testing software for computer entertainment systems allows the operations that are entered by the user into the system's manual controller (or “game pad”) to be recorded. A test version of a software title includes code that initializes a library that is configured to record controller data for testing purposes. The controller data from the manual controller is received in a host and is then stored. The captured controller data can then be used to reproduce the bug or other flaw. The library may also be configured to retrieve controller data from storage for testing purposes to implement a playback function. The retrieved controller data is sent to an operating system for the entertainment system to emulate controller input data when running the game or other software.

### BACKGROUND OF THE INVENTION

1. Field of the Invention

The present invention relates generally to computer entertainment systems, and more specifically to techniques and schemes for use in testing games and other software for such systems.

2. Discussion of the Related Art

Computer entertainment game systems have become some of the most successful consumer electronics products to hit store shelves in recent years. New video games for such systems are constantly being developed. As part of its development each new video game must be thoroughly tested to find bugs and other flaws in the game. A Game Tester Engineer (GTE) is a person who plays a beta version of a video game for long periods of time in order to perform such testing.

It is with respect to these and other background information factors that the present invention has evolved.

### SUMMARY OF THE INVENTION

The present invention advantageously addresses the needs above as well as other needs by providing a method for use in testing software. The method comprises the steps of: running a software title in an entertainment system having a manual controller for inputting controller data to the entertainment system; initializing a library that is configured to record controller data for testing purposes; receiving controller data from the manual controller for controlling operations of the software title; and storing the controller data.

Another embodiment of the present invention provides a method for use in testing software. The method comprises the steps of: running a software title in an entertainment system having a manual controller for inputting controller data to the entertainment system; initializing a library that is configured to retrieve controller data from storage for testing purposes; retrieving controller data from storage; and sending the retrieved controller data to an operating system for the entertainment system to control operations of the software title.

Another embodiment of the present invention provides a system for use in testing software. The system comprises: means for communicating with an entertainment system having a manual controller for inputting controller data to the entertainment system; means for storing a library that is configured to record controller data for testing purposes; means for receiving controller data from the manual controller while the entertainment system is running a software title; and means for storing the controller data.

Another embodiment of the present invention provides a computer program product comprising a medium for embodying a computer program for input to a computer. A computer program is embodied in the medium for causing the computer to perform steps of: receiving a communication from an entertainment system having a manual controller for inputting controller data to the entertainment system; getting controller data from the manual controller while the entertainment system is running a software title; and storing the controller data for testing purposes.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a system for use in testing software in accordance with an embodiment of the present invention;

FIG. 2 is a flow diagram illustrating an example of a method that may be used with the system shown in FIG. 1 in accordance with an embodiment of the present invention;

FIG. 3 is a block diagram illustrating a system for use in testing software in accordance with an embodiment of the present invention; and

FIG. 4 is a flow diagram illustrating an example of a method that may be used with the system shown in FIG. 3 in accordance with an embodiment of the present invention.

Corresponding reference characters indicate corresponding components throughout the several views of the drawings.

### DETAILED DESCRIPTION

During the testing of a new video game a Game Tester Engineer (GTE) will sometimes perform an operation or sequence of operations that will cause the video game to crash or otherwise not function properly. Because many video games require the user to manipulate the buttons and other controls of the manual controller (or “game pad”) very rapidly, the GTE may not be able to remember the exact sequence of operations that caused the video game to crash. This makes it more difficult to isolate the bug or other flaw in the software of the video game.

Embodiments of the present invention help to overcome these and other disadvantages by providing techniques and schemes that may be used in the testing of video games and other software. Such techniques and schemes may be used as part of a First Party Quality Assurance (FPQA) program. Furthermore, embodiments of the present invention can be particularly suited for operation with entertainment systems such as game consoles, which typically have unique platforms and operating systems that are different than personal computer (PC) platforms and operating systems.

In general, embodiments of the present invention allow the operations that are entered by the user into the manual controller of an entertainment system to be recorded. This captured controller input data can then be sent to the software development team to reproduce the bug, which ultimately helps them to correct the bug. In other embodiments of the present invention, the captured controller input data can be displayed on the screen associated with the entertainment system during game play as a reference for the GTE. This helps to remind the GTE what he or she was doing when the game crashed, i.e. which buttons he or she was pressing. In still other embodiments of the present invention controller data can be retrieved from storage and sent to the entertainment system's operating system to emulate controller input data when running the game or other software.

Embodiments of the present invention may be implemented in general purpose software that can be easily added-on to software titles and the library that provides the interface to the manual controller. The techniques and schemes have a low impact on performance and overhead. Furthermore, since the techniques and schemes may be implemented as an add-on procedure, little programming is needed to remove or bypass the library from the final build of the software. The techniques and schemes described herein may be used for the testing of many different types of software applications and not just video games.

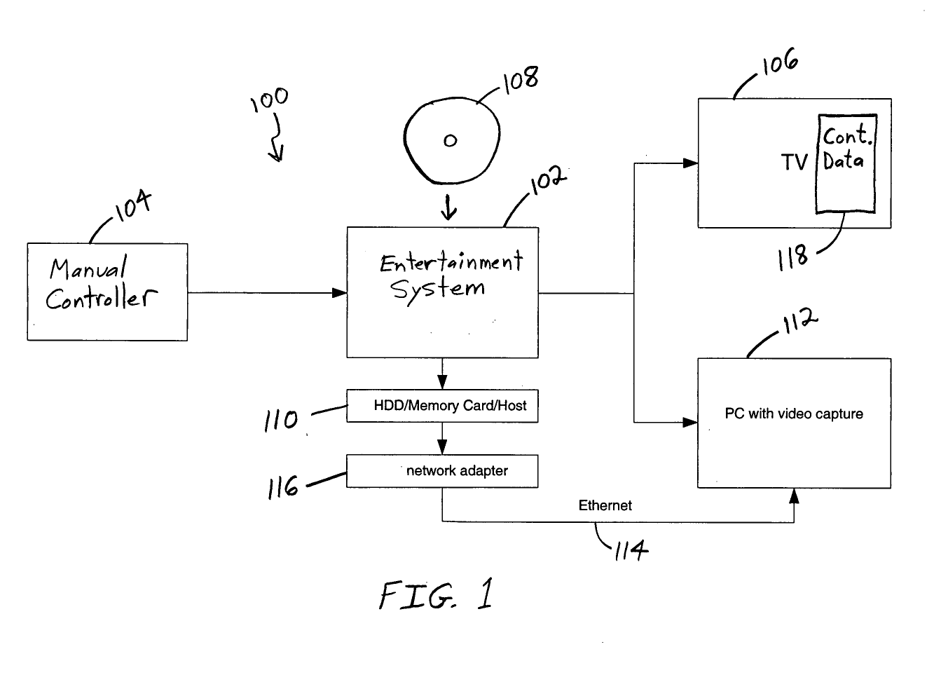

Referring to FIG. 1, there is illustrated a system 100 that operates in accordance with an embodiment of the present invention. The system 100, which may be used for testing software such as video games, includes an entertainment system 102, such as a video game console or the like. In some embodiments of the present invention the entertainment system 102 may comprise a development game console having debugging capabilities and/or the capability of connecting to another computer, such a host computer.

The entertainment system 102 includes an associated manual controller or “game pad” 104 for inputting controller data to the entertainment system. The inputted controller data can control the operations of whatever software title is being run by the entertainment system 102. A television or other video display 106 is included for displaying the video images generated by the entertainment system 102.

A software title 108, such as a video game or other software application, is typically embodied on a DVD, CD, or other computer readable medium. The software title 108 is inserted into the entertainment system 102.

A host 110 is connected to communicate with the entertainment system 102. The host 110 includes a library that is configured to record the data generated by the manual controller 104 for testing purposes. The host 110 may comprise a hard disk drive (HDD), memory card, or any other type of storage device. The recorded controller data may be stored on this storage device. The host 110 stores a program that has the library linked inside. The program may be either self-driven such as for example by a development kit, or the program may be driven by the host. In the later scenario the host 110 may also comprise a computer, such as a personal computer or any other type of computer.

In some embodiments of the present invention the host 110 is separate from the entertainment system 102. In other embodiments of the present invention the host 110 may be embodied in the same system as the entertainment system 102.

In some embodiments of the present invention an additional computer 112 with video capture capabilities may be connected to the entertainment system 102 for recording the video that is output by the entertainment system 102. The additional computer 112 may also be connected to the host 110 via an Ethernet connection 114 to a network adapter 116. This way the recorded video may be synchronized with the recorded controller data to aid in the analysis of the bug or flaw in the software title 108. An explorer program or the like may be included in the additional computer 112 in order to operate with the operating system of the entertainment system 102.

It was mentioned above that the captured controller input data can be displayed on the screen associated with the entertainment system during game play as a reference for the GTE. An example of this is illustrated by designator 118 which shows controller data being displayed on the screen of the television or other video display 106.

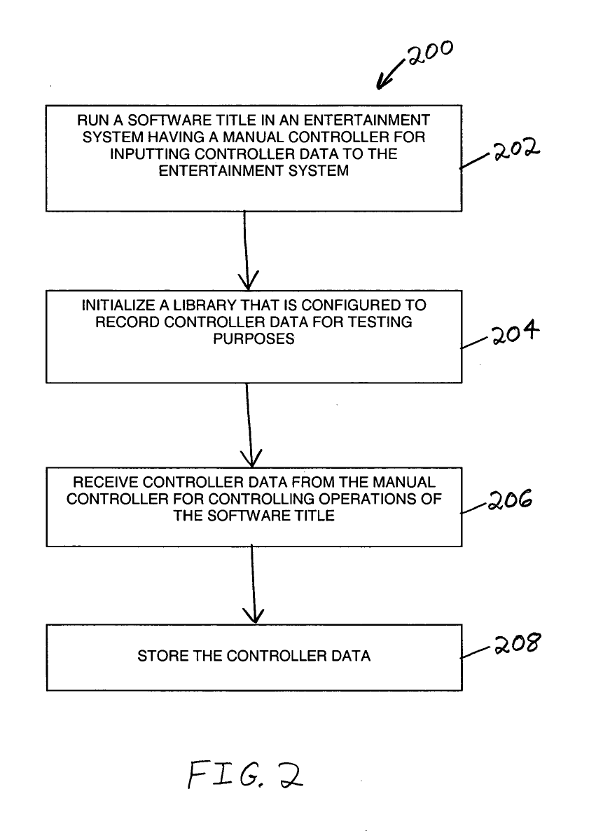

Referring to FIG. 2, there is illustrated a method 200 that operates in accordance with an embodiment of the present invention. By way of example, the method 200 may be used for operating the system 100 shown in FIG. 1 for use in testing video games or other software and recording data from the manual controller. First, in step 202 a video game or other software title is run on an entertainment system having a manual controller for inputting controller data to the entertainment system.

In step 204 a library that is configured to record controller data for testing purposes is initialized. By way of example, the library may comprise a device driver level library, namely, an added layer on top of the standard library that provides the interface to the entertainment system's manual controller. The standard library, which is often provided to game developers, typically sits on top of the Linear Programming (LP) module and IO Processor (IOP) libraries, which in turn sit on the physical layer. Wrapping a layer above the standard library provides the ability to get the data generated by the manual controller for storing it.

The library may be stored and run in the host separate from the entertainment system. Furthermore, the library may be the same library used for many or all video games and/or software titles. Thus, most of the software for implementing various embodiments of the present invention may be stored on the host storage devices.

In some embodiments of the present invention the library is initialized, or called, by the software title. For example, the version of the software title that is being tested can have some extra lines of code in it for referencing or calling the library. These extra lines of code can either be removed or bypassed for the final version of the software title. In some embodiments the IOP module may need to be loaded first, and then the library can be initialized.

In step 206 controller data from the manual controller for controlling operations of the software title is received. This controller data is the data generated by the manual controller as a result of the user manipulating the manual controller's buttons and other controls. For examples the signals coming from the manual controller that are sent to the operating system of the entertainment system are received by the host.

And in step 208 the received controller data is stored. The received controller data may be stored in any storage device, such as for example the hard disk drive (HDD), memory card, or other storage device associated with the host. Again, these devices may be separate from the entertainment system. In this way the operations entered into the manual controller by the user manipulating the buttons and other controls of the manual controller can be captured and stored.

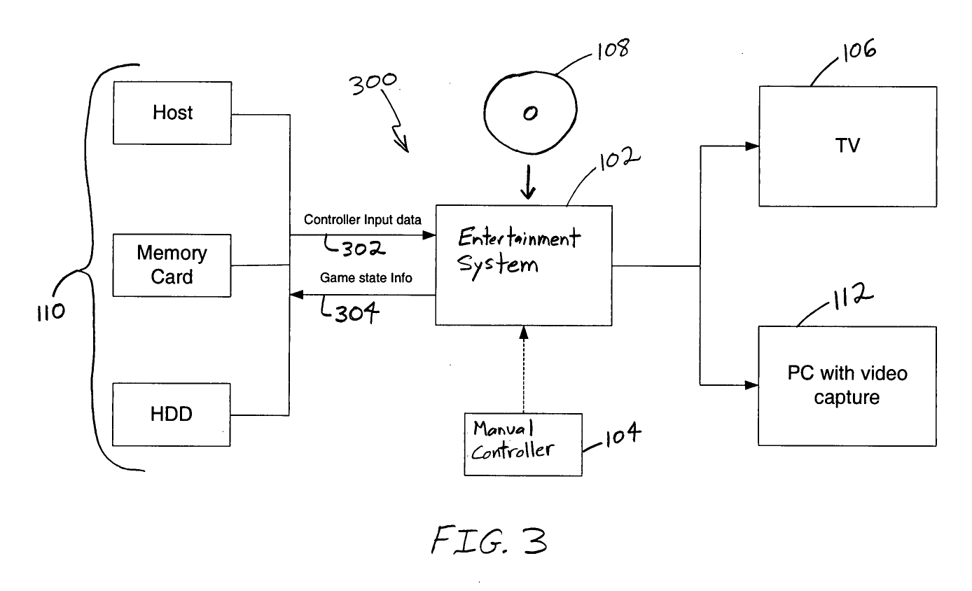

Referring to FIG. 3, there is illustrated a system 300 that operates in accordance with another embodiment of the present invention. Namely, the system 300 may be used for playing back stored controller data to analyze the system performance. The system 300 includes substantially the same components as the system 100, including the entertainment system 102, manual controller 104, television or other video display 106, software title 108, host 110, and additional computer 112 with video capture capabilities.

In general, playback is performed by retrieving stored controller data from storage and then sending the retrieved controller data to the operating system of the entertainment system. The flow of the retrieved controller data is indicated by designator 302. In the playback scenario the entertainment system 102 uses the retrieved controller data indicated by 302 instead of data from the manual controller 104, which is why the connection of the manual controller 104 to the entertainment system 102 is indicated with a dashed line. Furthermore, in order to synchronize the retrieved controller data with the video game being played, game state information is sent to the host as indicated by designator 304.

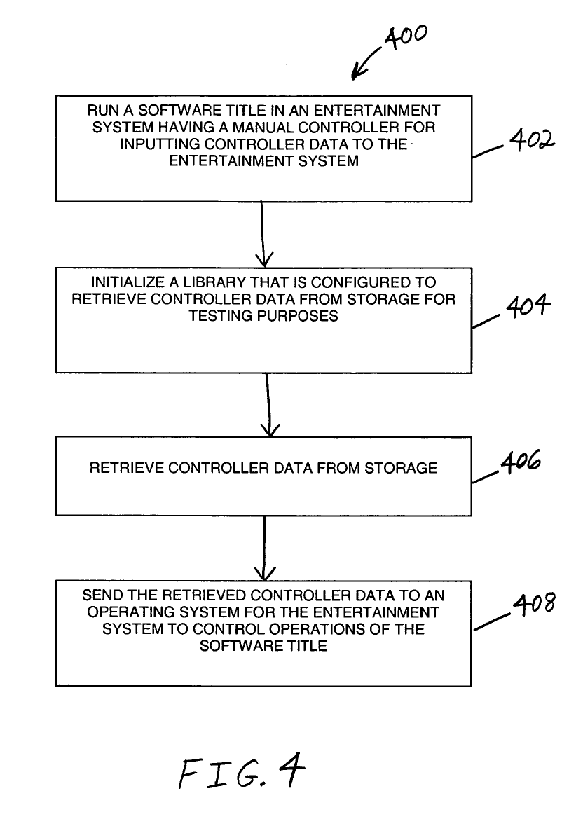

Referring to FIG. 4, there is illustrated a method 400 that operates in accordance with an embodiment of the present invention. By way of example, the method 400 may be used for operating the system 300 shown in FIG. 3 for use in testing video games or other software. First, in step 402 a software title is run in an entertainment system having a manual controller for inputting controller data to the entertainment system.

In step 404 a library that is configured to retrieve controller data from storage for testing purposes is initialized. The library may be implemented similar to as described above. Indeed, in some embodiments of the present invention the same library may implement both the record and playback functions. Furthermore, similar to as described above, the library may be stored in the host storage devices separate from the entertainment system, and the library may be initialized, or called, by the software title. For example, the test version of the software title may have some extra lines of code in it for referencing or calling the library.

In step 406 controller data is retrieved from storage. The retrieved controller data may, for example, comprise data that was previously received and recorded from a manual controller, random data, predefined data, or some combination of these types of data. The use of data that was previously received and recorded from a manual controller is helpful for isolating a bug or flaw in the software title in the scenario where the recorded controller data caused the software to crash or malfunction. For example, a video game can be replayed using exactly the same controller input data to determine where and when the crash occurred.

The use of random data may be used to automatically emulate random controller input data to simulate a monkey testing the software to find bugs and malfunctions that may cause the software to crash.

The use of pre-defined data may be used to automatically emulate controller input data to test many different scenarios of the software title. For example, in a sports video game title all of the different combinations of teams, uniforms, stadiums, weather conditions, etc. can be tested. The use of pre-defined data may also be used to automatically emulate controller input data to test a software title's basic operation scenario. This provides an automated build verification test and build regression test. Thus, basic testing can be performed automatically before a GTE is used for testing. The automated testing is much cheaper than a GTE, so it can be performed first to work out many bugs and flaws. Then a GTE can be used.

In step 408 the retrieved controller data is sent to an operating system for the entertainment system to control operations of the software title. In other words, the software title is controlled by the retrieved controller data instead of the controller data generated by the manual controller.

The following is a portion of code similar to what may be found in a conventional video game software title for initializing a standard library and getting the manual controller data, i.e. pad data:

Load IOP Modules:

Call sceSifLoadModule( ) to load sio2man.irx and
padman.irx

Initialize the library:

Call scePadInit( ) to initialize the libpad

Get button information:

Call scePadRead( )

Exit operations:

Call scePadEnd( )

In this portion of code libpad is the standard library that provides the interface to the entertainment system's manual controller.

In accordance with an embodiment of the present invention, this portion of code can be modified as follows to implement a record and playback function as described above:

Load IOP Modules:

Call sceSifLoadModule( ) to load sio2man.irx and
padman.irx

Initialize the library:

Replace scePadInit to fpqa_scePadInit( ) does
{

Call scePadInit( );
Initialize the fpqaPS2CONTROLS.

}

Get button information:

| replace scePadRead( ) to fpqa_scePadRead( ) does | |
|---|---|
| { | if capture the pad data |

{
call scePadRead( ) to get the pad-data;
store the pad-data to fpqaPS2CONTROLS.
return the pad-data;
}
if replay the pad data
{
get the pad data from fpqaPS2CONTROLS.
return the pad data
}

}

Exit operations:

Call scePadEnd( )

In this portion of code fpqa—scePadInit( ) initializes a library that is configured to record and retrieve controller data to and from storage, respectively, for testing purposes in accordance with an embodiment of the present invention. Thus, this code implements both the record and playback function. The code that is shown in brackets { } is located in the library, which as described above may be located and run in the host. The other call commands are located in the software title as mentioned above.

Thus, in some embodiments of the present invention controller data can be recorded and/or played back by modifying one or more of the normal call commands in the software title. For example, the call commands for initializing the library and getting the pad data can be modified. This way the library is referenced from within the software title. The library receives the pad data and records it, i.e. stores it. The library may comprise an added layer above the normal, standard library used for implementing the controller data function, i.e. the standard library used for getting the button information from the manual controller. The library can also be configured to retrieve controller data from storage and send it to the operating system for the entertainment system to implement a playback function.

While the invention herein disclosed has been described by means of specific embodiments and applications thereof, numerous modifications and variations could be made thereto by those skilled in the art without departing from the scope of the invention set forth in the claims.

What is claimed is:

1. A method for use in testing software, comprising the steps of:
running a software title in an entertainment system having a manual controller for inputting controller data to the entertainment system;
initializing a library that is configured to record controller data for testing purposes;
receiving controller data from the manual controller for controlling operations of the software title; and
storing the controller data.

2. A method in accordance with claim 1, wherein the step of initializing a library is performed by the software title.

3. A method in accordance with claim 1, wherein the library is stored in a device that is separate from the entertainment system.

4. A method in accordance with claim 1, wherein the step of receiving controller data from the manual controller comprises the step of:
receiving the controller data in a device that is separate from the entertainment system.

5. A method in accordance with claim 1, wherein the step of storing the controller data comprises the step of:
storing the controller data in a device that is separate from the entertainment system.

6. A method in accordance with claim 1, further comprising the step of:
displaying the stored controller data on a display screen of the entertainment system while the software title is running.

7. A method in accordance with claim 1, further comprising the step of:
recording video that is output by the entertainment system running the software title.

8. A method in accordance with claim 1, further comprising the steps of:
retrieving the controller data from storage;
sending the retrieved controller data to an operating system for the entertainment system to control operations of the software title.

9. A method in accordance with claim 8, wherein the step of retrieving the controller data from storage comprises the step of:
retrieving the controller data from storage that is separate from the entertainment system.

10. A method for use in testing software, comprising the steps of:
running a software title in an entertainment system having a manual controller for inputting controller data to the entertainment system;
initializing a library that is configured to retrieve controller data from storage for testing purposes;
retrieving controller data from storage; and
sending the retrieved controller data to an operating system for the entertainment system to control operations of the software title.

11. A method in accordance with claim 10, wherein the retrieved controller data comprises data that was previously received from a manual controller.

12. A method in accordance with claim 10, wherein the retrieved controller data comprises random data.

13. A method in accordance with claim 10, wherein the retrieved controller data comprises predefined data.

14. A method in accordance with claim 10, wherein the step of initializing a library is performed by the software title.

15. A method in accordance with claim 10, wherein the library is stored in a device that is separate from the entertainment system.

16. A method in accordance with claim 10, wherein the step of retrieving controller data from storage comprises the step of:
retrieving the controller data from a device that is separate from the entertainment system.

17. A system for use in testing software, comprising:
means for communicating with an entertainment system having a manual controller for inputting controller data to the entertainment system;
means for storing a library that is configured to record controller data for testing purposes;
means for receiving controller data from the manual controller while the entertainment system is running a software title; and
means for storing the controller data.

18. A system in accordance with claim 17, wherein the means for storing a library comprises a device that is separate from the entertainment system.

19. A system in accordance with claim 17, wherein the means for receiving controller data from the manual controller comprises a device that is separate from the entertainment system.

20. A system in accordance with claim 17, wherein the means for storing the controller data comprises a device that is separate from the entertainment system.

21. A system in accordance with claim 17, further comprising:
means for receiving an instruction from the software title to initialize the library.

22. A computer program product comprising a medium for embodying a computer program for input to a computer and a computer program embodied in the medium for causing the computer to perform steps of:
receiving a communication from an entertainment system having a manual controller for inputting controller data to the entertainment system;
getting controller data from the manual controller while the entertainment system is running a software title; and
storing the controller data for testing purposes.

23. A computer program product in accordance with claim 22, wherein the medium comprises a device that is separate from the entertainment system.

24. A computer program product in accordance with claim 22, wherein the step of storing the controller data comprises the step of: storing the controller data in a device that is separate from the entertainment system.

25. A computer program product in accordance with claim 22, further comprising the step of:
communicating with a computer that is configured to record video that is output by the entertainment system running the software title.

26. A computer program product in accordance with claim 22, further comprising the steps of:
retrieving the controller data from storage;
sending the retrieved controller data to an operating system for the entertainment system to control operations of the software title.
